(19) United States
(12) Patent Application Publication
(10) Pub. No.: US 2026/0304487 A1
(43) Pub. Date: Oct. 1, 2026

(54) METHOD FOR SPLIT PRACH FORMAT TRANSMISSION

(71) Applicant: Nokia Technologies Oy, Espoo (FI)

(72) Inventors: Alessio MARCONE, Munich (DE); Nhat-Quang NHAN, Reims (FR); Frank FREDERIKSEN, Klarup (DK); Marco MASO, Issy les Moulineaux (FR)

(21) Appl. No.: 18/998,189

(22) PCT Filed: Aug. 1, 2023
(86) PCT No.: PCT/EP2023/071241

§ 371 Date: Jan. 24, 2025

Related U.S. Application Data
(60) Provisional application No. 63/395,413, filed on Aug. 5, 2022.

(51) Int. Cl. H04W 74/0833; H04W 72/0453

(52) U.S. Cl. CPC H04W 74/0833; H04W 72/0453

(57) ABSTRACT

An apparatus may be configured to perform: receive a physical random access channel configuration from a network node; generate a random access preamble based on the received physical random access channel configuration; generate a frequency domain representation of the generated random access preamble; determine a plurality of parts of the generated frequency domain representation; and transmit respective parts of the determined plurality of parts in respective occasions. An apparatus may be configured to perform: transmit, to a user equipment, a physical random access channel configuration; receive, from the user equipment, respective parts of a plurality of parts of a frequency domain representation of a random access preamble in respective occasions; and reconstruct the frequency domain representation of the random access preamble based, at least partially, on the received plurality of parts to determine the random access preamble.

### TECHNICAL FIELD

The example and non-limiting embodiments relate generally to PRACH procedure and, more particularly, to preamble transmission.

### BACKGROUND

It is known, in a random access procedure, to transmit a preamble as part of message 1.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: receive a physical random access channel configuration from a network node; generate a random access preamble based on the received physical random access channel configuration; generate a frequency domain representation of the generated random access preamble; determine a plurality of parts of the generated frequency domain representation; and transmit respective parts of the determined plurality of parts in respective occasions.

In accordance with one aspect, a method comprising: receiving, with/by a user equipment, a physical random access channel configuration from a network node; generating a random access preamble based on the received physical random access channel configuration; generating a frequency domain representation of the generated random access preamble; determining a plurality of parts of the generated frequency domain representation; and transmitting respective parts of the determined plurality of parts in respective occasions.

In accordance with one aspect, an apparatus comprising means for performing: receiving a physical random access channel configuration from a network node; generating a random access preamble based on the received physical random access channel configuration; generating a frequency domain representation of the generated random access preamble; determining a plurality of parts of the generated frequency domain representation; and transmitting respective parts of the determined plurality of parts in respective occasions.

In accordance with one aspect, a non-transitory computer-readable medium comprising instructions stored thereon which, when executed with at least one processor, cause the at least one processor to: cause receiving of a physical random access channel configuration from a network node; generate a random access preamble based on the received physical random access channel configuration; generate a frequency domain representation of the generated random access preamble; determine a plurality of parts of the generated frequency domain representation; and cause transmitting of respective parts of the determined plurality of parts in respective occasions.

In accordance with one aspect, an apparatus comprising: at least one processor; and at least one memory storing instructions that, when executed by the at least one processor, cause the apparatus at least to: transmit, to a user equipment, a physical random access channel configuration; receive, from the user equipment, respective parts of a plurality of parts of a frequency domain representation of a random access preamble in respective occasions; and reconstruct the frequency domain representation of the random access preamble based, at least partially, on the received plurality of parts to determine the random access preamble.

In accordance with one aspect, a method comprising: transmitting, to a user equipment, a physical random access channel configuration; receiving, from the user equipment, respective parts of a plurality of parts of a frequency domain representation of a random access preamble in respective occasions; and reconstructing the frequency domain representation of the random access preamble based, at least partially, on the received plurality of parts to determine the random access preamble.

In accordance with one aspect, an apparatus comprising means for performing: transmitting, to a user equipment, a physical random access channel configuration; receiving, from the user equipment, respective parts of a plurality of parts of a frequency domain representation of a random access preamble in respective occasions; and reconstructing the frequency domain representation of the random access preamble based, at least partially, on the received plurality of parts to determine the random access preamble.

In accordance with one aspect, a non-transitory computer-readable medium comprising instructions stored thereon which, when executed with at least one processor, cause the at least one processor to: cause transmitting, to a user equipment, of a physical random access channel configuration; cause receiving, from the user equipment, of respective parts of a plurality of parts of a frequency domain representation of a random access preamble in respective occasions; and reconstruct the frequency domain representation of the random access preamble based, at least partially, on the received plurality of parts to determine the random access preamble.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4A is a diagram illustrating features as described herein;

FIG. 4B is a diagram illustrating features as described herein;

FIG. 4C is a diagram illustrating features as described herein;

FIG. 5 is a diagram illustrating features as described herein;

FIG. 6 is a flowchart illustrating steps as described herein; and

FIG. 7 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
ACK acknowledgement
AMF access and mobility management function
CBRA contention based random access
cRAN cloud radio access network
CRC cyclic redundancy check
CU central unit
DCI downlink control information
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
EPRE energy per resource element
E-UTRA evolved universal terrestrial radio access, i.e., the LTE radio access technology
FFT fast Fourier transform
gNB (or gNodeB) base station for 5G/NR, i.e., a node providing NR user plane and control plane protocol terminations towards the UE, and connected via the NG interface to the 5GC
I/F interface
L1 layer 1
LTE long term evolution
MAC medium access control
MIB master information block
MME mobility management entity
Msg1 message 1
Msg2 message 2
Msg3 message 3
Msg4 message 4
ng or NG new generation
ng-eNB or NG-eNB new generation eNB
NR new radio
NTN non terrestrial network
N/W or NW network
OFDM orthogonal frequency division multiplexing
O-RAN open radio access network
PBCH physical broadcast channel
PDCP packet data convergence protocol
PDU payload data unit
PHY physical layer
PRACH physical random access channel
PSD power spectral density
PUCCH physical uplink control channel
PUSCH physical uplink shared channel
RACH random access channel
RAN radio access network
RAPID random access preamble ID
RAR random access response
RA-RNTI random access radio network temporary identifier
RB resource block
RE resource element
RF radio frequency
RLC radio link control
RNTI radio network temporary identifier
RO random access channel occasion
RRC radio resource control
RRH remote radio head
RS reference signal
RU radio unit
Rx receiver
SDAP service data adaptation protocol
SGW serving gateway
SIB system information block
SMF session management function
SNR signal to noise ratio
SSB synchronization signal block
TC-RNTI temporary cell radio network temporary identifier
Tx transmitter
UE user equipment (e.g., a wireless, typically mobile device)
UPF user plane function
VNR virtualized network function
VoIP voice over internet protocol

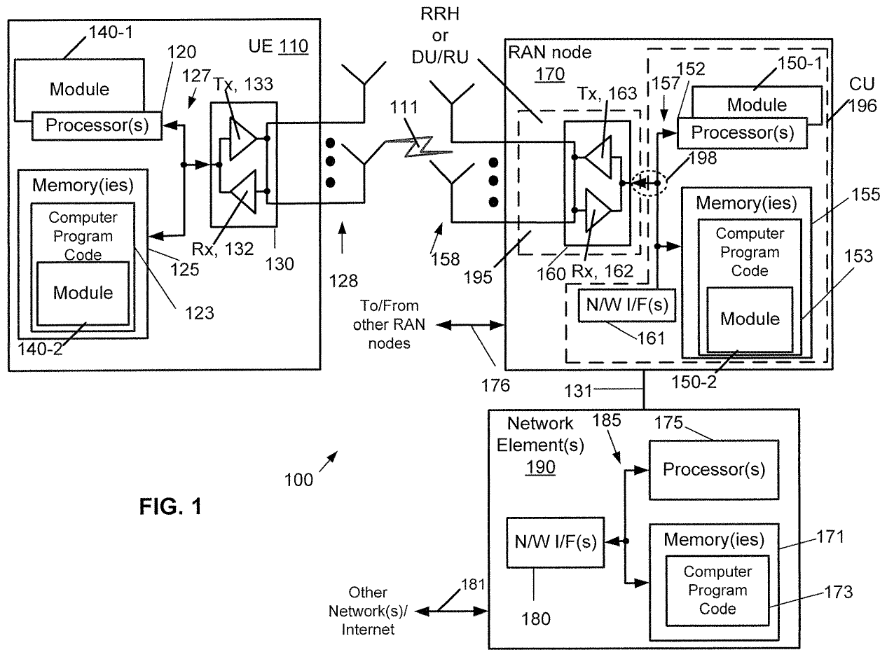

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMFF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, PAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the example embodiments of the present disclosure, example embodiments will now be described with greater specificity.

Features as described herein generally relate to random access channel (RACH) procedure(s). In 5G NR, two contention based random access (CBRA) procedures are supported, namely 4-step RACH (Rel-15) and 2-step RACH (Rel-16). Example embodiments of the present disclosure may discuss the 4-step RACH procedure, but this is not limiting; example embodiments of the present disclosure may also be applicable to the 2-step RACH procedure and/or other procedures.

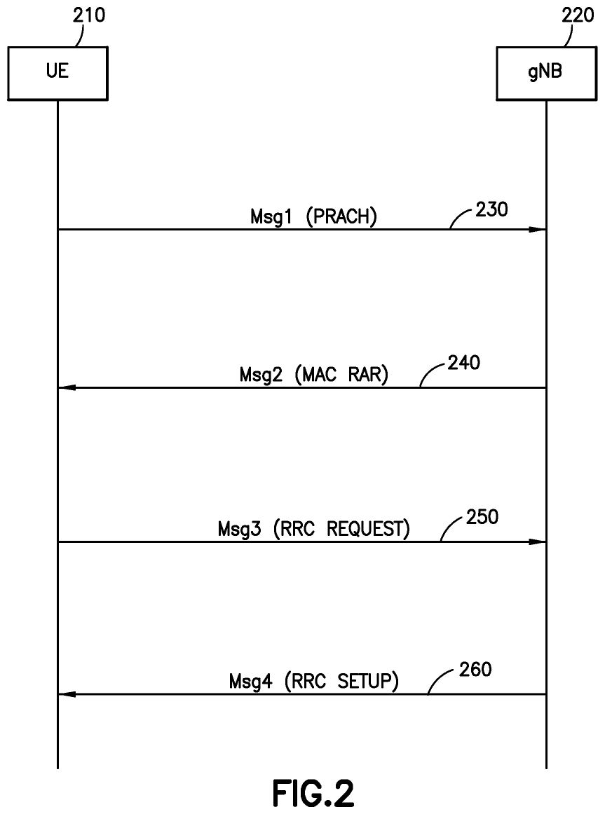

Referring now to FIG. 2, illustrated is an example of the 4-step RACH procedure. In the 4-step RACH procedure, a UE (210) may transmit, to a gNB (220), a Msg1, also known as a physical random access channel (PRACH) message (230). The UE (210) may send a specific preamble to the gNB (220) via the Msg1/PRACH using a specific resource called a RACH occasion (RO). The gNB (220) may, in response, transmit to the UE (210) a Msg2, also known as a random-access response (RAR) message (240), which may include the detected preamble ID, the time-advance command, a temporary cell radio network temporary identifier (TC-RNTI), and a UL grant for the transmission of Msg3 on the physical uplink shared channel (PUSCH). The UE (210) may, in response, transmit to the gNB (220) a Msg3, also known as a radio resource control (RRC) request (250), over the scheduled PUSCH with an ID for contention resolution. The gNB (220) may transmit, to the UE (210) a Msg4, also known as an RRC setup message (260). The RRC setup message may be a contention resolution message with the contention-resolution ID.

Upon reception of Msg4 (260), the UE (210) may send an ACK on a physical uplink control channel (PUCCH) if its contention-resolution ID is carried by Msg4 (260). This may complete the 4-step RACH. It may be noted that prior to Msg1 (230), there may also be a preliminary step of sending and receiving the synchronization signal block (SSB), i.e., DL beam sweeping, which is not formally part of the RACH procedure. As a result of this preliminary step, the UE (210) may select the index of the preferred SSB beam and decode the associated physical broadcast channel (PBCH) for the master information block (MIB), system information block (SIB), and so on. This index may also be used by UE (210) to identify a suitable RO for the preamble transmission (Msg1, 230), according to the SSB-to-RO mapping implicitly conveyed by SIB1.

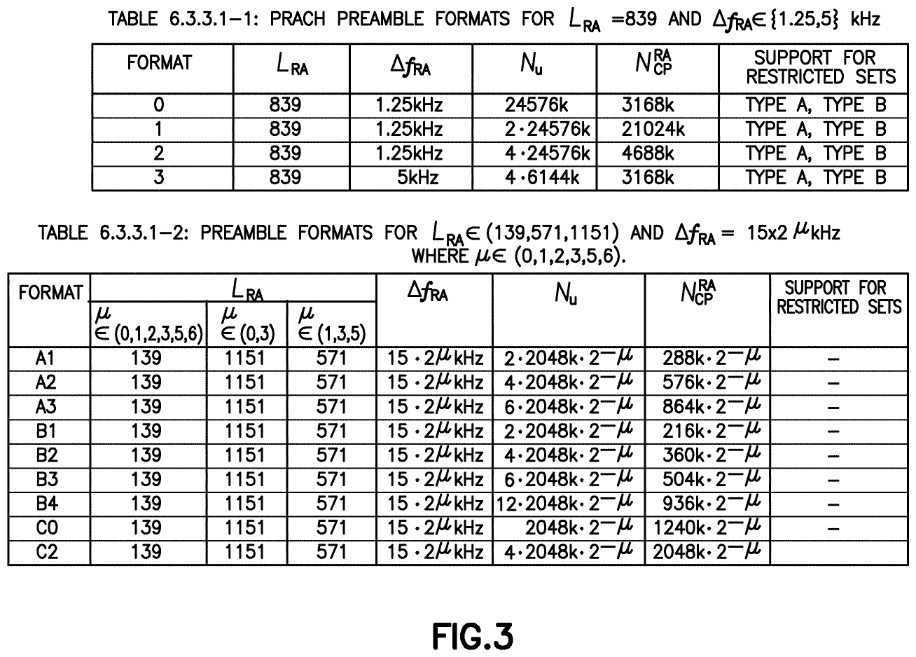

Referring now to FIG. 3, illustrated are several preamble formats that are currently defined in 3GPP RAN1 specifications (TS 38.211). Each format is characterized by specific length (L_{RA}) and sub-carrier spacings (Δf_{RA}), which determine their performance and characteristics. As an example, PRACH format B4 has a sequence length of 139 (for all SCSs) and is characterized by 12 repetitions of the same sequence of length 139. This allows format B4 to be quite robust in low signal to noise ratio (SNR) scenarios.

Generation of a PRACH sequence in time-domain follows a two-step process, as specified in TS 38.211:
“ . . . The set of random-access preambles x_{u,v}(n) shall be generated according to

$${x}_{u , v} ( n ) = {x}_{u} ( ( n + {C}_{v} ) mod ( {L}_{RA} )$$

$${x}_{u} ( i ) = {e}^{- j \frac{π ui ( i + 1 )}{{L}_{RA}}} , i = 0 , 1 , … , {L}_{RA} - 1$$

from which the frequency-domain representation shall be generated according to

$${y}_{u , v} ( n ) = {\sum }_{m = 0}^{{L}_{RA} - 1} {x}_{u , v} ( m ) \cdot {e}^{- j \frac{2 π mn}{{L}_{RA}}}$$

where L_{RA}=839, L_{RA}=139, L_{RA}=1151, or L_{RA}=571 depending on the PRACH preamble format as given by Tables 6.3.3.1-1 and 6.3.3.1-2 . . . ”

In a first step, a Zadouff-Chu sequence of length L_{RA} is generated, cyclically shifted by an amount Cᵥ, and converted in frequency domain by a fast Fourier transform (FFT) of size L_{RA}. In a second step, the frequency domain representation is transformed again in time domain after allocation in pre-determined sub-carriers within the channel bandwidth. The final time domain sequence is consecutively repeated M times based on the PRACH format, within a random access channel occasion. For format B4, the final sequence is repeated M=12 times.

UEs in coverage shortage and low SNR are typically characterized by large propagation losses to the serving gNB, and so are expected to transmit at maximum power. In such cases, and considering UEs' ability to adapt the power spectral density of the transmitted signal based on the allocated resources in frequency domain, a relationship exists between the energy per resource element (EPRE) that a UE is able to deliver, and the amount of resources allocated to the UE for transmission. More specifically, the larger the number of resources in the frequency domain (i.e. transmission bandwidth), the lower the EPRE for a same transmit maximum power and, conversely, the smaller the number of frequency domain resources, the larger the EPRE at maximum power. This means that the best allocation for a UE in coverage shortage may be characterized by a small number of frequency domain resources and a large number of time domain resources, to maximize the EPRE and, finally, the received SNR per sub-carrier. This optimization is generally possible and can be handled by the network scheduler when scheduling resources for a PUSCH or PUCCH transmission. Indeed, PUCCH formats typically used (and scheduled) for UEs at low SNR are the so called “long” formats, characterized by a large extension in the time domain (up to 14 orthogonal frequency division multiplexed (OFDM) symbols).

However, and differently from PUSCH or PUCCH, PRACH frequency and time domain allocation is fixed and based on sequence length, as described above. For example, for a so-called PRACH short format, such as format B4, the allocation may be 139 sub-carriers, equivalent to 12 resource blocks (RB) within the channel bandwidth, and 12 repetitions in the time domain occupying one whole RACH occasion. As described above, such a constraint in the allocation in the frequency domain (12 RBs) puts a constraint on the EPRE a UE may be able to deliver at maximum power, representing a limitation especially for UEs in coverage shortage. As a matter of fact, such UEs typically transmit at maximum power, and a fixed allocation in the frequency domain does not allow to maximize the achievable EPRE, and finally the received (at gNB) SNR per subcarrier.

A technical effect of example embodiments of the present disclosure may be to provide methods for reduction of the allocation in frequency domain of a PRACH format, and hence for maximization of the achievable EPRE for the PRACH format and related preamble. A technical effect of example embodiments of the present disclosure may be to consider and address related challenges, such as worse detection performance for shorter sequences and backward compatibility with PRACH receivers.

As a non-exhaustive example, PRACH receivers typically exploit the PRACH preamble repetitions structure (e.g. 12 preamble repetitions in one RACH occasion for format B4) to perform the correlation processing in the frequency domain to detect the transmitted preamble sequence. For this operation, it is of utmost importance that the back-to-back preamble repetitions are identical, so that the receiver can convert a circularly convolved signal, for each repetition, in the frequency domain with a simple FFT. Such a processing would not be possible if, for example, a single preamble sequence in the frequency domain was split in half (e.g. to reduce its frequency span) and the second half concatenated, in time domain and after time domain transformation, to the first half, since the resulting sequences would not be identical, thereby not enabling circular convolution of the channel with the transmitted signal repetition.

A technical effect of example embodiments of the present disclosure may be to optimize the EPRE for a UE in coverage shortage and requiring maximum power for transmission of a PRACH preamble for initial access.

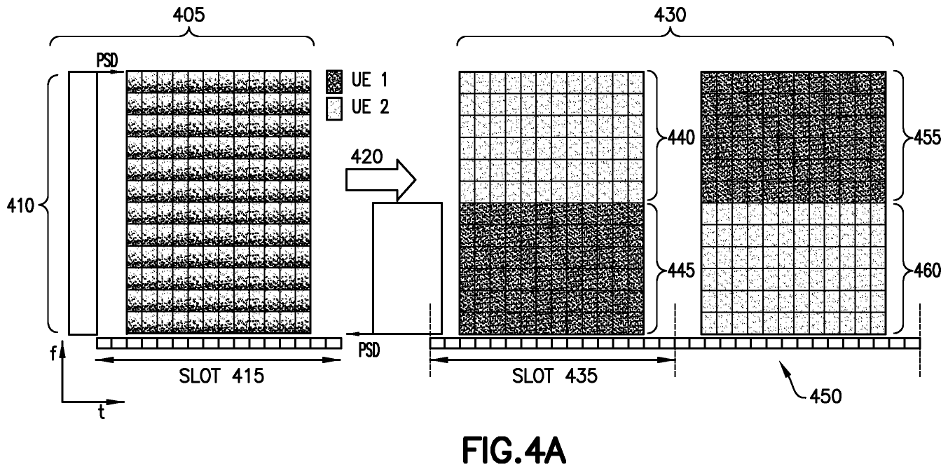

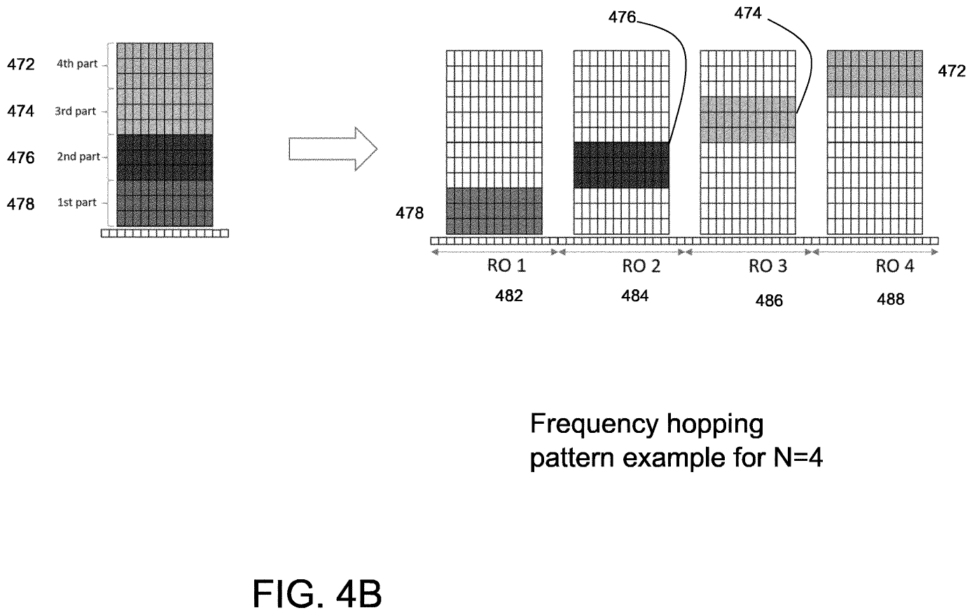

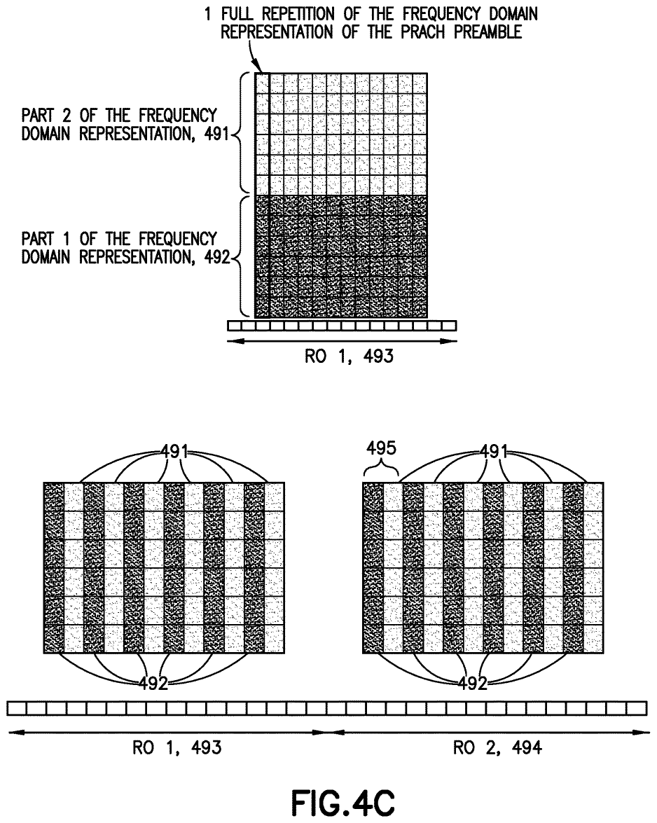

In an example embodiment, a method may be provided for adapting existing PRACH formats and related preambles to smaller allocations in the frequency domain, and larger allocations in the time domain. In an example embodiment, the PRACH preamble may be adapted across multiple RACH occasions belonging to a same SSB index. Referring now to FIG. 4A, illustrated is an example in which two UEs (UE1 and UE2) are transmitting the same or different preamble in the same RO, before and after application (420) of an example embodiment of the present disclosure. The left portion (405) represents a legacy operation, whereas the right portion (430) represents an example embodiment of the present disclosure. The single PRACH preamble for a UE (UE1 or UE2) may be split in half in the frequency domain and may be distributed in two consecutive ROs (e.g. one RO per slot in the example of FIG. 4A) in the same or different frequency bins. For example, UE1 may transmit the PRACH preamble across frequencies 410 in a legacy procedure, but according to an example embodiment of the present disclosure, UE1 may transmit to a subset of the frequencies 445 during a first RO 435, and may transmit to a different subset of the frequencies 455 during a second RO 450. For example, UE2 may transmit the PRACH preamble across frequencies 410 in a legacy procedure, but according to an example embodiment of the present disclosure, may transmit to a subset of the frequencies 440 during a first RO 435, and may transmit to a different subset of the frequencies 460 during a second RO 450. As also shown in FIG. 4A, in an example embodiment a UE may be able to double its transmitted power spectral density (PSD) in the single slot, and hence improve the received SNR per sub-carrier by, for example, 3 dB with the same number of occupied frequency resources, in total considering both RO 435 and 450, as in legacy operation.

In an example embodiment, a plurality of parts of the PRACH may be transmitted in respective occasions, such as random access channel occasions, or transmission occasions that are defined as a random access occasion and subsequent transmission occasions. In the case of transmission occasions, the first part of the plurality of parts may be transmitted in a random access channel occasion and the subsequent parts may be transmitted in transmission occasions implicitly defined from the random access channel occasion. While the term “RO” is generally used in the present disclosure, this is not limiting; a person having ordinary skill in the art would understand that an occasion for transmission, other than an occasion for random access channel transmission, may be substituted in example embodiments of the present disclosure. In other words, the terms “RO,” “respective occasion,” “transmission occasion,” and “subsequent transmission occasion” may be interchangeably used in the present disclosure.

In the present disclosure, a “part” may be one of multiple parts into which a PRACH preamble may be split according to an example embodiment. For example, a part may be a subset of the PRACH preamble in the frequency domain; in the example of FIG. 4A, the PRACH preamble transmitted by UE1 may be split, in the frequency domain, into parts 445 and 455. In the example of FIG. 4A, these parts (of the PRACH preamble) do not overlap in the frequency domain, and may be transmitted at different times (e.g. during different slots, 435, 450). The respective parts of the PRACH preamble may be transmitted during respective transmission occasions; in the example of FIG. 4A, the lower frequency part of the PRACH preamble transmitted by UE1 (445) may be transmitted during a first transmission occasion (435), while the higher frequency part of the PRACH preamble transmitted by UE1 (455) may be transmitted during a second transmission occasion (450).

For example, a UE may determine an RO for transmission of the first part of the plurality of parts mapped to a synchronization signal block, and may then transmit the subsequent parts of the plurality of parts in the next subsequent RO mapped to the same synchronization signal block index.

In an example embodiment, PRACH transmissions may be split per RACH occasion. A non-limiting example of splitting a PRACH sequence may be to split the frequency domain representation of the sequence in N parts in the frequency domain, and transmit the N parts in N different RACH occasions (ROs) in the time domain.

In an example embodiment, the frequency domain representation of the PRACH sequence may be composed of L symbols, which may be mapped into resource elements and/or resource blocks. The frequency domain representation may be split into N parts before the L symbols are mapped into resource elements and/or resource blocks, such that each of the N parts includes L/N symbols of the PRACH sequence. These symbols of the PRACH sequence may be considered elements of the frequency domain representation. The N parts may comprise L/N consecutive elements of the frequency domain representation. Alternatively, the N parts may comprise L/N non-consecutive elements of the frequency domain representation, which may have the technical effect of increasing the diversity of the channel affecting the originally consecutive symbols of the sequence.

In an example embodiment, the respective occasions may belong to the same or different slots.

A technical effect of example embodiments of the present disclosure may be to preserve the possibility of FFT processing at the receiver since the same parts of the frequency domain representations of each repeated sequence may be transmitted back-to-back in the same RO. For example, in order for the receiver/gNB to determine a frequency domain representation of the received N parts, the channel may perform a circular convolution on the transmitted PRACH signal. The circular convolution may be obtained by the transmitter/UE introducing a cyclic prefix before the first repetition of the set of repetitions for each of the N parts. Cyclic prefix is not necessary for the other repetitions of each of the N parts since each repetition may function as a cyclic prefix for the next repetition. In other words, the first repetition in one of the N parts includes a cyclic prefix, while the remainder of the repetitions in the one of the N parts does not include the cyclic prefix.

For example, if format B4 is used, each sequence is repeated 12 times within an RO. If each sequence is split into N parts according to an example embodiment of the present disclosure, for example N=2, the number of transmissions in the time domain may be 24, as there are two parts for each repetition. Referring to FIG. 4A, each transmission occasion (435, 450) may include 12 repetitions of the parts for each of UE1 and UE2. For example, each transmission occasion (435, 450) may enable transmission of 12 RBs. For example, for UE1, the sequence is split into 2 parts, 445 and 455, each of which is to be repeated 12 times within the respective RO (435, 450) to create the 24 repetitions across two ROs. The lower frequency part (445) may be repeated 12 times in RO 435, and the higher frequency part (455) may be repeated 12 times in RO 450. The lower frequency part (445) may be transmitted separately from the higher frequency part (455). For example, for UE2, the sequence is split into 2 parts, 440 and 460, each of which is to be repeated 12 times within the respective RO (435, 450) to create 24 repetitions across two ROs. The higher frequency part (440) may be repeated 12 times in RO 435, and the lower frequency part (460) may be repeated 12 times in RO 450. The higher frequency part (440) may be transmitted separately from the lower frequency part (460). A technical effect of this example embodiment may be that the receiver/gNB may perform FFT on the received signals, as the repetitions within each RO may act as cyclic prefix to each other such that the gNB may determine the frequency domain representation of each of the N parts.

Alternatively, the repetitions of the parts may be transmitted back to back (i.e. interlaced/concatenated), for example, for N=2 as in FIG. 4C, a repetition of the lower frequency part (492) may be transmitted, followed by a repetition of the higher frequency part (491), in an alternating manner in the RO (e.g. example of RO1 (493)). In other words, each RO (493, 494) contains repetitions of both of the N parts. While this may have the technical effect of allowing full repetitions of the sequence (i.e. both lower frequency part and higher frequency part for N=2) to be received in a same RO (i.e. a shorter time, see e.g. 495), the repetitions may not be able to act as cyclic prefix to each other, and the receiver may not be able to derive a correct frequency domain representation of each of the N parts (e.g. via FFT processing). This may present backward compatibility problems. A technical effect of example embodiments of the present disclosure may be to provide an advantage compared to, for example, interlacing the N parts of each repetition of the PRACH sequence.

In an example embodiment, the N parts of the PRACH sequence may be transmitted in N different ROs, but in the same or different subset of frequency resources spanned by the RO.

In the example of FIG. 4A, the UEs may transmit the N=2 parts of the PRACH sequence in different subsets (445, 455) of the frequency resources (410) spanned by the ROs (435, 450). In an example, where the ROs in the two consecutive slots span 12 RBs each in the frequency domain, UE1 may transmit the first part of the sequence in the first 6 RBs of the first RO (435), whereas UE2 may transmit the first part of the sequence in the second 6 RBs of the first RO (435). Conversely, in the second RO (450), UE1 may transmit the second part in the second 6 RBs and UE2 may transmit the second part in the first 6 RBs.

In an example embodiment, for example considering also cases where N>2, a frequency hopping pattern may be followed for transmissions on the subsets of frequency resources in the N different ROs, where the pattern may depend on the subset of frequency resources of the RO where the first part of the plurality of parts is transmitted. Such a subset may be referred to as the starting subset of the frequency resources and may be chosen randomly by the UE (e.g. based on the output of a random number generator).

For example, if the frequency domain representation of the preamble sequence is split in N parts, and transmitted in N different RO in the time domain, each RO spanning a set of L frequency resources, the first part of the N parts may be transmitted in the first lowest L/N resources of the set of L frequency resources, a second part of the N parts may be transmitted in the second lowest L/N resources of the set of L frequency resources, and the N-th part of the N parts may be transmitted in the N-th lowest L/N resources of the set of L frequency resources. For example, if L=144 and if the frequency resources were enumerated from 0 to 143, and N=2, the first part of the two parts may be transmitted in the resources from 0 to L/N−1=71 and the second part of the two parts may be transmitted in the resources from L/N=72 to 144.

Referring now to FIG. 4B, illustrated is an example of a frequency hopping pattern for N=4. The preamble sequency may be split into 4 parts, a first part (478), a second part (476), a third part (474), and a fourth part (472). This example is not limiting; in another example the highest frequency part may be considered the 1st part, while the lowest frequency part may be considered the Nth part. In an example frequency hopping pattern, the 1st part (478) may be transmitted in a first RO (482); the 2nd part (476) may be transmitted in second RO (484); the 3rd part (474) may be transmitted in a third RO (486); and the 4th part (472) may be transmitted in a fourth RO (488). This example frequency hopping pattern is not limiting; other patterns are possible.

In an example embodiment, a receiver (gNB) may be configured to process the split preamble(s). For example, a gNB may be configured to enable it to process a received split preamble.

In an example embodiment, since the single (N) parts may not be reliably detected by the receiver/gNB, the gNB may first wait to receive all the N parts across multiple ROs. In the example of FIG. 4A, the gNB may wait to receive the signal from the two consecutive ROs (435, 450).

In an example embodiment, the gNB may then re-construct the entire sequence from the N parts and perform cross-correlation of the entire sequence to detect which preamble was transmitted.

In an example embodiment, a UE may be configured to transmit the split preamble(s). For example, a UE may receive a configuration configured to enable it to generate and transmit split preamble(s).

In an example embodiment, after generating the basic Zadouff-Chu sequence (based on the steps of TS 38.211), the UE may split the corresponding frequency domain representation into the indicated N parts.

In an example embodiment, the UE may transmit the N parts in N different ROs, each part being constructed as indicated by the corresponding PRACH format. For example, for PRACH format B4, the basic sequence may be repeated consecutively 12 times (in the same RO) and a cyclic prefix may be added only at the start of the first repetition. For transmission of the split preamble, each of the N parts may be repeated 12 times in one RO and transmitted.

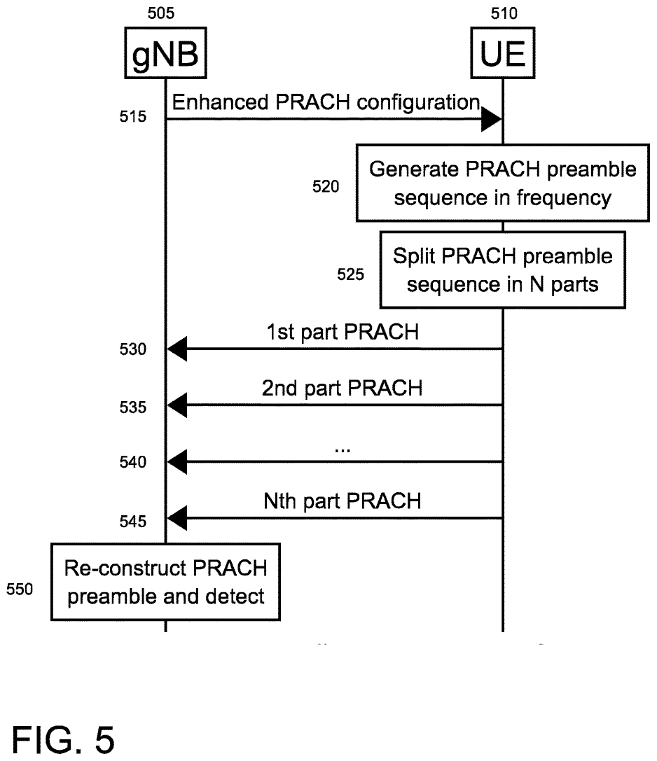

Referring now to FIG. 5, illustrated is a flowchart according to example embodiments of the present disclosure. A UE (510) may receive, from a gNB (505), an enhanced PRACH configuration (515) including, in addition to the typical PRACH parameters, an indication of the number N of parts to split the PRACH sequence into. The UE (510) may generate the PRACH sequence based on the preamble format indicated in the PRACH parameters, first in time and then in frequency domain (520). The UE (510) may split the generated PRACH sequence in the frequency domain into N parts (525). For example, for a PRACH format B4 of length 139 and a value of N=2, the UE (510) may split the original sequence occupying 12 RBs into two parts, each occupying 6 RBs. The UE (510) may transmit, to the gNB (505), the N parts in N different ROs in a same or different subset of frequency resources spanned by the Ros (530, 535, 540, 545). The gNB (505) may wait to receive the N parts of the PRACH preamble across the N ROs, re-construct the entire sequence from the N parts, and perform cross-correlation of the entire sequence to detect which preamble was transmitted (550).

A technical effect of example embodiments of the present disclosure may be to optimize the EPRE for a UE in coverage shortage and requiring maximum power for transmission of a PRACH preamble for initial access. A technical effect of example embodiments of the present disclosure may be to allow a UE to double its transmitted PSD in the single slot, and hence improve the received SNR per sub-carrier by, for example, 3 dB with the same number of occupied frequency resources compared with legacy operation.

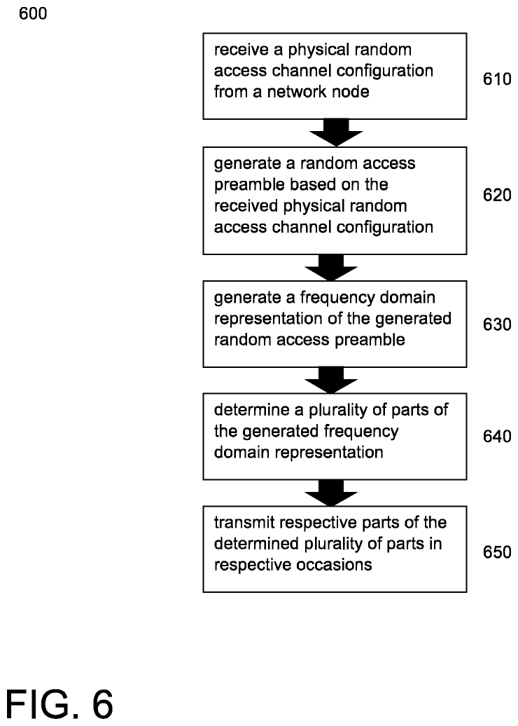

FIG. 6 illustrates the potential steps of an example method 600. The example method 600 may include: receiving a physical random access channel configuration from a network node, 610; generating a random access preamble based on the received physical random access channel configuration, 620; generating a frequency domain representation of the generated random access preamble, 630; determining a plurality of parts of the generated frequency domain representation, 640; and transmitting respective parts of the determined plurality of parts in respective occasions, 650. The example method 600 may be performed, for example, by a UE and/or a transmitting entity.

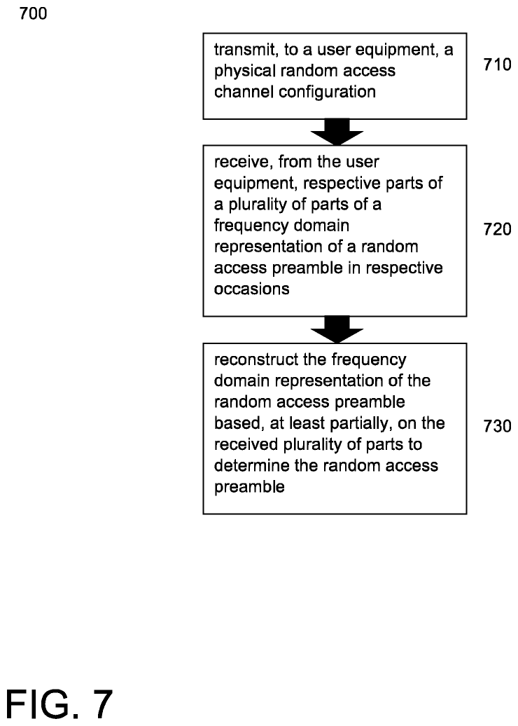

FIG. 7 illustrates the potential steps of an example method 700. The example method 700 may include: transmitting, to a user equipment, a physical random access channel configuration, 710; receiving, from the user equipment, respective parts of a plurality of parts of a frequency domain representation of a random access preamble in respective occasions, 720; and reconstructing the frequency domain representation of the random access preamble based, at least partially, on the received plurality of parts to determine the random access preamble, 730. The example method 700 may be performed, for example, by a base station, gNB, and/or receiving entity.

In accordance with one example embodiment, an apparatus may comprise: at least one processor; and at least one memory storing instructions that, when executed by the at least one processor, cause the apparatus at least to: receive a physical random access channel configuration from a network node; generate a random access preamble based on the received physical random access channel configuration; generate a frequency domain representation of the generated random access preamble; determine a plurality of parts of the generated frequency domain representation; and transmit respective parts of the determined plurality of parts in respective occasions.

The example apparatus may be further configured to: determine that the apparatus is in a coverage shortage mode; and determine to use maximum power for transmitting of the respective parts of the determined plurality of parts in the respective occasions.

The respective occasions may comprise one of: random access channel occasions, or transmission occasions comprising at least one random access occasion and one or more subsequent transmission occasions.

The received physical random access channel configuration may comprise a first value.

Determining the plurality of parts of the generated frequency domain representation may comprise the example apparatus being configured to: split the generated frequency domain representation into a number of respective parts equal to the first value.

The length of the respective parts of the determined plurality of parts may be equal to a length of the generated frequency domain representation divided by the first value.

Splitting the generated frequency domain representation may comprise the example apparatus being configured to: select consecutive elements of the generated frequency domain representation.

Splitting the generated frequency domain representation may comprise the example apparatus being configured to: select non-consecutive elements of the generated frequency domain representation.

Transmitting the respective parts of the determined plurality of parts in the respective occasions may comprise the example apparatus being configured to: transmit the respective parts of the determined plurality of parts in respective occasions of a number of occasions equal to the first value.

The respective occasions may occupy a set of frequency resources.

A first occasion of the respective occasions may occupy a first set of frequency resources, wherein a second occasion of the respective occasions may occupy a second set of frequency resources, wherein the first set of frequency resources may be at least partially different from the second set of frequency resources.

A first occasion of the respective occasions may occupy a first set of frequency resources during a first time period, wherein a second occasion of the respective occasions may occupy the first set of frequency resources during a second time period, wherein the first time period and the second time period may be at least partially different.

The respective occasions may be associated with a same synchronization signal block index.

The respective parts of the determined plurality of parts may be respectively transmitted in a same subset of a set of frequency resources occupied by the respective occasions.

The respective parts of the determined plurality of parts may be respectively transmitted in different subsets of a set of frequency resources occupied by the respective occasions.

The different subsets of the set of frequency resources may be determined based, at least partially, on a subset of the set of frequency resources used for transmission of a first respective part of the determined plurality of parts.

The random access preamble may be generated according to a determined physical random access channel format.

Transmitting the respective parts of the determined plurality of parts in the respective occasions may comprise the example apparatus being configured to: transmit the respective parts in respective occasions that may be different in a time domain.

The respective occasions may belong to a same slot.

The respective occasions may belong to different slots.

The example apparatus may be further configured to: determine a plurality of occasions for transmission in the time domain, wherein the plurality of occasions may comprise, at least, the respective occasions.

In accordance with one aspect, an example method may be provided comprising: receiving, by a user equipment, a physical random access channel configuration from a network node; generating a random access preamble based on the received physical random access channel configuration; generating a frequency domain representation of the generated random access preamble; determining a plurality of parts of the generated frequency domain representation; and transmitting respective parts of the determined plurality of parts in respective occasions.

The respective occasions may comprise one of: random access channel occasions, or transmission occasions comprising at least one random access occasion and one or more subsequent transmission occasions.

The received physical random access channel configuration may comprise a first value.

The determining of the plurality of parts of the generated frequency domain representation may comprise: splitting the generated frequency domain representation into a number of respective parts equal to the first value.

A length of the respective parts of the determined plurality of parts may be equal to a length of the generated frequency domain representation divided by the first value.

The splitting of the generated frequency domain representation may comprise: selecting consecutive elements of the generated frequency domain representation.

The splitting of the generated frequency domain representation may comprise: selecting non-consecutive elements of the generated frequency domain representation.

Transmitting of the respective parts of the determined plurality of parts in the respective occasions may comprise: transmitting the respective parts of the determined plurality of parts in respective occasions of a number of occasions equal to the first value.

The respective occasions may occupy a set of frequency resources.

A first occasion of the respective occasions may occupy a first set of frequency resources, wherein a second occasion of the respective occasions may occupy a second set of frequency resources, wherein the first set of frequency resources may be at least partially different from the second set of frequency resources.

A first occasion of the respective occasions may occupy a first set of frequency resources during a first time period, wherein a second occasion of the respective occasions may occupy the first set of frequency resources during a second time period, wherein the first time period and the second time period may be at least partially different.

The respective occasions may be associated with a same synchronization signal block index.

The respective parts of the determined plurality of parts may be respectively transmitted in a same subset of a set of frequency resources occupied by the respective occasions.

The respective parts of the determined plurality of parts may be respectively transmitted in different subsets of a set of frequency resources occupied by the respective occasions.

The different subsets of the set of frequency resources may be determined based, at least partially, on a subset of the set of frequency resources used for transmission of a first respective part of the determined plurality of parts.

The transmitting of the respective parts of the determined plurality of parts in the respective occasions may comprise: transmitting the respective parts in respective occasions that are different in a time domain.

The respective occasions may belong to a same slot.

The respective occasions may belong to different slots.

The example method may further comprise: determining a plurality of occasions for transmission in the time domain, wherein the plurality of occasions may comprise, at least, the respective occasions.

In accordance with one example embodiment, an apparatus may comprise: circuitry configured to perform: receiving, by a user equipment, a physical random access channel configuration from a network node; circuitry configured to perform: generating a random access preamble based on the received physical random access channel configuration; circuitry configured to perform: generating a frequency domain representation of the generated random access preamble; circuitry configured to perform: determining a plurality of parts of the generated frequency domain representation; and circuitry configured to perform: transmitting respective parts of the determined plurality of parts in respective occasions.

In accordance with one example embodiment, an apparatus may comprise: processing circuitry; memory circuitry including computer program code, the memory circuitry and the computer program code configured to, with the processing circuitry, enable the apparatus to: receive a physical random access channel configuration from a network node; generate a random access preamble based on the received physical random access channel configuration; generate a frequency domain representation of the generated random access preamble; determine a plurality of parts of the generated frequency domain representation; and transmit respective parts of the determined plurality of parts in respective occasions.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: receiving a physical random access channel configuration from a network node; generating a random access preamble based on the received physical random access channel configuration; generating a frequency domain representation of the generated random access preamble; determining a plurality of parts of the generated frequency domain representation; and transmitting respective parts of the determined plurality of parts in respective occasions.

The respective occasions may comprise one of: random access channel occasions, or transmission occasions comprising at least one random access occasion and one or more subsequent transmission occasions.

The received physical random access channel configuration may comprise a first value.

The means configured to perform determining the plurality of parts of the generated frequency domain representation may comprise means configured to perform: splitting the generated frequency domain representation into a number of respective parts equal to the first value.

A length of the respective parts of the determined plurality of parts may be equal to a length of the generated frequency domain representation divided by the first value.

The means configured to perform splitting the generated frequency domain representation may comprise means configured to perform: selecting consecutive elements of the generated frequency domain representation.

The means configured to perform splitting the generated frequency domain representation may comprise means configured to perform: selecting non-consecutive elements of the generated frequency domain representation.

The means configured to perform transmitting the respective parts of the determined plurality of parts in the respective occasions may comprise means configured to perform: transmitting the respective parts of the determined plurality of parts in respective occasions of a number of occasions equal to the first value.

The respective occasions may occupy a set of frequency resources.

A first occasion of the respective occasions may occupy a first set of frequency resources, wherein a second occasion of the respective occasions may occupy a second set of frequency resources, wherein the first set of frequency resources may be at least partially different from the second set of frequency resources.

A first occasion of the respective occasions may occupy a first set of frequency resources during a first time period, wherein a second occasion of the respective occasions may occupy the first set of frequency resources during a second time period, wherein the first time period and the second time period may be at least partially different.

The respective occasions may be associated with a same synchronization signal block index.

The respective parts of the determined plurality of parts may be respectively transmitted in a same subset of a set of frequency resources occupied by the respective occasions.

The respective parts of the determined plurality of parts may be respectively transmitted in different subsets of a set of frequency resources occupied by the respective occasions.

The different subsets of the set of frequency resources may be determined based, at least partially, on a subset of the set of frequency resources used for transmission of a first respective part of the determined plurality of parts.

The random access preamble may be generated according to a determined physical random access channel format.

The means configured to perform transmitting the respective parts of the determined plurality of parts in the respective occasions may comprise means configured to perform: transmitting the respective parts in respective occasions that may be different in a time domain.

The respective occasions may belong to a same slot.

The respective occasions may belong to different slots.

The means may be further configured to perform: determining a plurality of occasions for transmission in the time domain, wherein the plurality of occasions may comprise, at least, the respective occasions.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: cause receiving of a physical random access channel configuration from a network node; generate a random access preamble based on the received physical random access channel configuration; generate a frequency domain representation of the generated random access preamble; determine a plurality of parts of the generated frequency domain representation; and cause transmitting of respective parts of the determined plurality of parts in respective occasions.

In accordance with another example embodiment, a non-transitory program storage device readable by a machine may be provided, tangibly embodying instructions executable by the machine for performing operations, the operations comprising: cause receiving of a physical random access channel configuration from a network node; generate a random access preamble based on the received physical random access channel configuration; generate a frequency domain representation of the generated random access preamble; determine a plurality of parts of the generated frequency domain representation; and cause transmitting of respective parts of the determined plurality of parts in respective occasions.

In accordance with another example embodiment, a non-transitory computer-readable medium comprising instructions that, when executed by an apparatus, cause the apparatus to perform at least the following: cause receiving of a physical random access channel configuration from a network node; generate a random access preamble based on the received physical random access channel configuration; generate a frequency domain representation of the generated random access preamble; determine a plurality of parts of the generated frequency domain representation; and cause transmitting of respective parts of the determined plurality of parts in respective occasions.

A computer implemented system comprising: at least one processor and at least one non-transitory memory storing instructions that, when executed by the at least one processor, cause the system at least to perform: receiving a physical random access channel configuration from a network node; generating a random access preamble based on the received physical random access channel configuration; generating a frequency domain representation of the generated random access preamble; determining a plurality of parts of the generated frequency domain representation; and transmitting respective parts of the determined plurality of parts in respective occasions.

A computer implemented system comprising: means for receiving a physical random access channel configuration from a network node; means for generating a random access preamble based on the received physical random access channel configuration; means for generating a frequency domain representation of the generated random access preamble; means for determining a plurality of parts of the generated frequency domain representation; and means for transmitting respective parts of the determined plurality of parts in respective occasions.

In accordance with one example embodiment, an apparatus may comprise: at least one processor; and at least one memory storing instructions that, when executed by the at least one processor, cause the apparatus at least to: transmit, to a user equipment, a physical random access channel configuration; receive, from the user equipment, respective parts of a plurality of parts of a frequency domain representation of a random access preamble in respective occasions; and reconstruct the frequency domain representation of the random access preamble based, at least partially, on the received plurality of parts to determine the random access preamble.

The example apparatus may be further configured to: determine that the apparatus is in a coverage shortage mode; and determine to use maximum power for transmitting of the respective parts of the determined plurality of parts in the respective occasions.

The respective occasions may comprise one of: random access channel occasions, or reception occasions comprising at least one random access occasion and one or more subsequent reception occasions.

The physical random access channel configuration may comprises a first value.

A number of the plurality of parts may be equal to the first value.

A number of the respective occasions may be equal to the first value.

A length of the respective parts of the plurality of parts may be equal to a length of the frequency domain representation divided by the first value.

Receiving the respective parts of the plurality of parts in the respective occasions may comprise the example apparatus being configured to: receive the respective parts of the plurality of parts in respective occasions of a number of occasions equal to the first value.

The respective occasions may occupy a set of frequency resources.

A first occasion of the respective occasions may occupy a first set of frequency resources, wherein a second occasion of the respective occasions may occupy a second set of frequency resources, wherein the first set of frequency resources may be at least partially different from the second set of frequency resources.

A first occasion of the respective occasions may occupy a first set of frequency resources during a first time period, wherein a second occasion of the respective occasions may occupy the first set of frequency resources during a second time period, wherein the first time period and the second time period may be at least partially different.

The respective occasions may be associated with a same synchronization signal block index.

The plurality of parts may be respectively received in a same subset of a set of frequency resources occupied by the respective occasions.

Respective parts of the plurality of parts may be respectively received in different subsets of a set of frequency resources occupied by the respective occasions.

The different subsets of the set of frequency resources may be determined based, at least partially, on a subset of the set of frequency resources used for reception of a first respective part of plurality of parts.

The respective parts may be transmitted in respective occasions that may be different in a time domain.

The respective occasions may belong to a same slot.

The respective occasions may belong to different slots.

In accordance with one aspect, an example method may be provided comprising: transmitting, to a user equipment, a physical random access channel configuration; receiving, from the user equipment, respective parts of a plurality of parts of a frequency domain representation of a random access preamble in respective occasions; and reconstructing the frequency domain representation of the random access preamble based, at least partially, on the received plurality of parts to determine the random access preamble.

The respective occasions may comprise one of: random access channel occasions, or reception occasions comprising at least one random access occasion and one or more subsequent reception occasions.

The physical random access channel configuration may comprise a first value.

A number of the plurality of parts may be equal to the first value.

A number of the respective occasions may be equal to the first value.

A length of the respective parts of the plurality of parts may be equal to a length of the frequency domain representation divided by the first value.

The receiving of the respective parts of the plurality of parts in the respective occasions may comprise: receiving the respective parts of the plurality of parts in respective occasions of a number of occasions equal to the first value.

The respective occasions may occupy a set of frequency resources.

A first occasion of the respective occasions may occupy a first set of frequency resources, wherein a second occasion of the respective occasions may occupy a second set of frequency resources, wherein the first set of frequency resources may be at least partially different from the second set of frequency resources.

A first occasion of the respective occasions may occupy a first set of frequency resources during a first time period, wherein a second occasion of the respective occasions may occupy the first set of frequency resources during a second time period, wherein the first time period and the second time period may be at least partially different.

The respective occasions may be associated with a same synchronization signal block index.

The plurality of parts may be respectively received in a same subset of a set of frequency resources occupied by the respective occasions.

Respective parts of the plurality of parts may be respectively received in different subsets of a set of frequency resources occupied by the respective occasions.

The different subsets of the set of frequency resources may be determined based, at least partially, on a subset of the set of frequency resources used for reception of a first respective part of plurality of parts.

The respective parts may be transmitted in respective occasions that may be different in a time domain.

The respective occasions may belong to a same slot.

The respective occasions may belong to different slots.

In accordance with one example embodiment, an apparatus may comprise: circuitry configured to perform: transmitting, to a user equipment, a physical random access channel configuration; circuitry configured to perform: receiving, from the user equipment, respective parts of a plurality of parts of a frequency domain representation of a random access preamble in respective occasions; and circuitry configured to perform: reconstructing the frequency domain representation of the random access preamble based, at least partially, on the received plurality of parts to determine the random access preamble.

In accordance with one example embodiment, an apparatus may comprise: processing circuitry; memory circuitry including computer program code, the memory circuitry and the computer program code configured to, with the processing circuitry, enable the apparatus to: transmit, to a user equipment, a physical random access channel configuration; receive, from the user equipment, respective parts of a plurality of parts of a frequency domain representation of a random access preamble in respective occasions; and reconstruct the frequency domain representation of the random access preamble based, at least partially, on the received plurality of parts to determine the random access preamble.

In accordance with one example embodiment, an apparatus may comprise means for performing: transmitting, to a user equipment, a physical random access channel configuration; receiving, from the user equipment, respective parts of a plurality of parts of a frequency domain representation of a random access preamble in respective occasions; and reconstructing the frequency domain representation of the random access preamble based, at least partially, on the received plurality of parts to determine the random access preamble.

The respective occasions may comprise one of: random access channel occasions, or reception occasions comprising at least one random access occasion and one or more subsequent reception occasions.

The physical random access channel configuration may comprise a first value.

A number of the plurality of parts may be equal to the first value.

A number of the respective occasions may be equal to the first value.

A length of the respective parts of the plurality of parts may be equal to a length of the frequency domain representation divided by the first value.

The means configured to perform receiving the respective parts of the plurality of parts in the respective occasions may comprise means configured to perform: receive the respective parts of the plurality of parts in respective occasions of a number of occasions equal to the first value.

The respective occasions may occupy a set of frequency resources.

A first occasion of the respective occasions may occupy a first set of frequency resources, wherein a second occasion of the respective occasions may occupy a second set of frequency resources, wherein the first set of frequency resources may be at least partially different from the second set of frequency resources.

A first occasion of the respective occasions may occupy a first set of frequency resources during a first time period, wherein a second occasion of the respective occasions may occupy the first set of frequency resources during a second time period, wherein the first time period and the second time period may be at least partially different.

The respective occasions may be associated with a same synchronization signal block index.

The plurality of parts may be respectively received in a same subset of a set of frequency resources occupied by the respective occasions.

Respective parts of the plurality of parts may be respectively received in different subsets of a set of frequency resources occupied by the respective occasions.

The different subsets of the set of frequency resources may be determined based, at least partially, on a subset of the set of frequency resources used for reception of a first respective part of plurality of parts.

The respective parts may be transmitted in respective occasions that may be different in a time domain.

The respective occasions may belong to a same slot.

The respective occasions may belong to different slots.

In accordance with one example embodiment, a non-transitory computer-readable medium comprising instructions stored thereon which, when executed with at least one processor, cause the at least one processor to: cause transmitting, to a user equipment, of a physical random access channel configuration; cause receiving, from the user equipment, of respective parts of a plurality of parts of a frequency domain representation of a random access preamble in respective occasions; and reconstruct the frequency domain representation of the random access preamble based, at least partially, on the received plurality of parts to determine the random access preamble.

In accordance with another example embodiment, a non-transitory program storage device readable by a machine may be provided, tangibly embodying instructions executable by the machine for performing operations, the operations comprising: cause transmitting, to a user equipment, of a physical random access channel configuration; cause receiving, from the user equipment, of respective parts of a plurality of parts of a frequency domain representation of a random access preamble in respective occasions; and reconstruct the frequency domain representation of the random access preamble based, at least partially, on the received plurality of parts to determine the random access preamble.

In accordance with another example embodiment, a non-transitory computer-readable medium comprising instructions that, when executed by an apparatus, cause the apparatus to perform at least the following: cause transmitting, to a user equipment, of a physical random access channel configuration; cause receiving, from the user equipment, of respective parts of a plurality of parts of a frequency domain representation of a random access preamble in respective occasions; and reconstruct the frequency domain representation of the random access preamble based, at least partially, on the received plurality of parts to determine the random access preamble.

A computer implemented system comprising: at least one processor and at least one non-transitory memory storing instructions that, when executed by the at least one processor, cause the system at least to perform: transmitting, to a user equipment, a physical random access channel configuration; receiving, from the user equipment, respective parts of a plurality of parts of a frequency domain representation of a random access preamble in respective occasions; and reconstructing the frequency domain representation of the random access preamble based, at least partially, on the received plurality of parts to determine the random access preamble.

A computer implemented system comprising: means for transmitting, to a user equipment, a physical random access channel configuration; means for receiving, from the user equipment, respective parts of a plurality of parts of a frequency domain representation of a random access preamble in respective occasions; and means for reconstructing the frequency domain representation of the random access preamble based, at least partially, on the received plurality of parts to determine the random access preamble.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1.-43. (canceled)

44. An apparatus comprising:
at least one processor; and
at least one non-transitory memory storing instructions that, when executed by the at least one processor, cause the apparatus at least to:
receive a physical random access channel configuration from a network node, wherein the received physical random access channel configuration comprises a first value;
generate a random access preamble based on the received physical random access channel configuration;
generate a frequency domain representation of the generated random access preamble;
determine a plurality of parts of the generated frequency domain representation by splitting the generated frequency domain representation into a number of respective parts equal to the first value and selecting consecutive elements of the generated frequency domain representation, wherein a length of the respective parts of the determined plurality of parts is equal to a length of the generated frequency domain representation divided by the first value; and
transmit respective parts of the determined plurality of parts in respective occasions of a number of occasions equal to the first value and that are different in a time domain, wherein the respective parts of the determined plurality of parts are respectively transmitted in different subsets of a set of frequency resources occupied by the respective occasions, and wherein the different subsets of the set of frequency resources are determined based, at least partially, on a subset of the set of frequency resources used for transmission of a first respective part of the determined plurality of parts.

45. The apparatus of claim 44, wherein the respective occasions comprise one of:
random access channel occasions, or
transmission occasions comprising at least one random access occasion and one or more subsequent transmission occasions.

46. The apparatus of claim 45, wherein the respective occasions occupy a set of frequency resources.

47. The apparatus of claim 46, wherein a first occasion of the respective occasions occupies a first set of frequency resources, wherein a second occasion of the respective occasions occupies a second set of frequency resources, wherein the first set of frequency resources is at least partially different from the second set of frequency resources.

48. The apparatus of claim 46, wherein a first occasion of the respective occasions occupies a first set of frequency resources during a first time period, wherein a second occasion of the respective occasions occupies the first set of frequency resources during a second time period, wherein the first time period and the second time period are at least partially different.

49. The apparatus of claim 48, wherein the respective occasions are associated with a same synchronization signal block index, and wherein the random access preamble is generated according to a determined physical random access channel format.

50. The apparatus of claim 49, wherein the respective occasions belong to a same slot.

51. A system comprising:
an apparatus;
at least one processor; and
at least one non-transitory memory storing instructions that, when executed by the at least one processor, cause the apparatus at least to:
receive a physical random access channel configuration from a network node, wherein the received physical random access channel configuration comprises a first value;
generate a random access preamble based on the received physical random access channel configuration;
generate a frequency domain representation of the generated random access preamble;
determine a plurality of parts of the generated frequency domain representation by splitting the generated frequency domain representation into a number of respective parts equal to the first value and selecting consecutive elements of the generated frequency domain representation, wherein a length of the respective parts of the determined plurality of parts is equal to a length of the generated frequency domain representation divided by the first value; and
transmit respective parts of the determined plurality of parts in respective occasions of a number of occasions equal to the first value and that are different in a time domain, wherein the respective parts of the determined plurality of parts are respectively transmitted in different subsets of a set of frequency resources occupied by the respective occasions, and wherein the different subsets of the set of frequency resources are determined based, at least partially, on a subset of the set of frequency resources used for transmission of a first respective part of the determined plurality of parts.

52. The system of claim 51, wherein the respective occasions comprise one of:
random access channel occasions, or
transmission occasions comprising at least one random access occasion and one or more subsequent transmission occasions.

53. The system of claim 52, wherein the respective occasions occupy a set of frequency resources.

54. The system of claim 53, wherein a first occasion of the respective occasions occupies a first set of frequency resources, wherein a second occasion of the respective occasions occupies a second set of frequency resources, wherein the first set of frequency resources is at least partially different from the second set of frequency resources.

55. The system of claim 53, wherein a first occasion of the respective occasions occupies a first set of frequency resources during a first time period, wherein a second occasion of the respective occasions occupies the first set of frequency resources during a second time period, wherein the first time period and the second time period are at least partially different.

56. The apparatus of claim 55, wherein the respective occasions are associated with a same synchronization signal block index, and wherein the random access preamble is generated according to a determined physical random access channel format.

57. The apparatus of claim 56, wherein the respective occasions belong to a same slot.

58. A method comprising:
receiving, by an apparatus, a physical random access channel configuration from a network node, wherein the received physical random access channel configuration comprises a first value;
generating a random access preamble based on the received physical random access channel configuration;
generating a frequency domain representation of the generated random access preamble;
determining a plurality of parts of the generated frequency domain representation by splitting the generated frequency domain representation into a number of respective parts equal to the first value and selecting consecutive elements of the generated frequency domain representation, wherein a length of the respective parts of the determined plurality of parts is equal to a length of the generated frequency domain representation divided by the first value; and
transmitting respective parts of the determined plurality of parts in respective occasions of a number of occasions equal to the first value and that are different in a time domain, wherein the respective parts of the determined plurality of parts are respectively transmitted in different subsets of a set of frequency resources occupied by the respective occasions, and wherein the different subsets of the set of frequency resources are determined based, at least partially, on a subset of the set of frequency resources used for transmission of a first respective part of the determined plurality of parts.

59. The method of claim 58, wherein the respective occasions comprise one of:
random access channel occasions, or
transmission occasions comprising at least one random access occasion and one or more subsequent transmission occasions.

60. The method of claim 59, wherein the respective occasions occupy a set of frequency resources.

61. The method of claim 60, wherein a first occasion of the respective occasions occupies a first set of frequency resources, wherein a second occasion of the respective occasions occupies a second set of frequency resources, wherein the first set of frequency resources is at least partially different from the second set of frequency resources.

62. The method of claim 60, wherein a first occasion of the respective occasions occupies a first set of frequency resources during a first time period, wherein a second occasion of the respective occasions occupies the first set of frequency resources during a second time period, wherein the first time period and the second time period are at least partially different.

63. The method of claim 62, wherein the respective occasions are associated with a same synchronization signal block index, and wherein the random access preamble is generated according to a determined physical random access channel format.
